(19) United States
(12) Patent Application Publication
(10) Pub. No.: US 2003/0177007 A1
(43) Pub. Date: Sep. 18, 2003

(54) Noise suppression apparatus and method for speech recognition, and speech recognition apparatus and method

(75) Inventors: Hiroshi Kanazawa, Kanagawa-ken (JP); Yoshifumi Nagata, Iwate-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/387,580

(22) Filed: Mar. 14, 2003

(30) Foreign Application Priority Data
Mar. 15, 2002 (JP) 2002-072881

(51) Int. Cl. G10L 15/20

(52) U.S. Cl. 704/233

(57) ABSTRACT

A target voice elimination unit reliably eliminates a target voice and outputs a target voice elimination signal including only a noise component. A target voice emphasis unit outputs a target voice emphasis signal from which a noise component is eliminated to some extent. A noise spectrum information extraction unit extracts noise spectrum information from the target voice elimination signal, and a target voice spectrum information extraction unit extracts target voice spectrum information from the target voice emphasis signal. A degree of multiplexing of noise estimation unit reliably detects the position where noise is superimposed and the magnitude of the noise from the noise spectrum information and the target voice spectrum information and obtains a degree of multiplexing of noise. A spectrum information correction unit reliably corrects the target voice spectrum information using the information of the degree of multiplexing of noise indicating the position and magnitude of the noise detected correctly. The influence of noise is greatly reduced in the spectrum information, thereby the accuracy of speech recognition can be improved.

This application claims benefit of Japanese Application No. 2002-072881 filed in Japan on Mar. 15, 2002, the contents of which are incorporated by this reference.

### BACKGROUND OF THE INVENTION

1. Field of the Invention

The present invention relates to a noise suppression apparatus and method for speech recognition for improving noise resistance by a microphone array using a plurality of microphones and to a speech recognition apparatus and method.

2. Description of the Related Art

Recently, with an improvement in the performance of a speech recognition technology, speech recognition engines vigorously go into actual use. In particular, great expectation is placed on speech recognition in circumstances in which input devices are limited as in automobile-navigation systems, mobile equipment, and the like.

In speech recognition processing, a result of speech recognition can be obtained by comparing an input voice captured from a microphone with recognizable vocabularies. Since there are various noise sources under a practical environment, a voice signal captured by the microphone is mixed with ambient noise. In the speech recognition processing, recognition accuracy is greatly influenced by the noise resistance.

FIG. 1 is a block diagram showing a noise suppression apparatus for obtaining a voice output by suppressing noise in a one-channel-input signal by employing a spectrum subtraction technology as the noise suppression technology.

A voice signal and a noise signal are input to input terminals 1 and 2. The input voice signal is supplied to an input voice spectrum information extraction unit 3. The input voice spectrum information extraction unit 3 extracts the characteristic amount (characteristic vector) of the input voice signal as an input signal spectrum.

In contrast, the input noise signal is supplied to a noise spectrum information extraction unit 4. The noise spectrum information extraction unit 4 extracts the characteristic amount (characteristic vector) of a noise waveform as a noise signal spectrum which is output to an S/N ratio estimation unit 5. The S/N ratio estimation unit 5 estimates an S/N ratio from the input signal spectrum and the noise signal spectrum and outputs the S/N ratio to a spectrum information correction unit 6.

The spectrum information correction unit 6 is also supplied with the input signal spectrum from the input voice spectrum information extraction unit 3 and removes a component superimposed with noise from the input signal spectrum. With this operation, an input signal spectrum from which noise is removed by the spectrum information correction unit 6 can be obtained, which is output to a speech recognition engine (not shown) as recognition spectrum information.

Incidentally, there is also known a technology for suppressing noise by means of a plurality of microphones as a technology for reducing noise mixed with a voice, in addition to the spectrum subtraction technology to the input two channel signal described above. For example, a document 1 (Acoustic System and Digital Processing edited by The Institute of Electronics, Information and Communication Engineers) and a document 2 (Adaptive Filter Theory by Simon Heykin, published by Plentice Hall) disclose an adaptive beam former processing technology using methods of a generalized sidelobe canceller (GSC), a Frost beam former, a reference signal method, and the like making use of a microphone array. The adaptive beam former processing is processing for suppressing noise by means of a filter having a dead angle formed in an interrupting noise coming direction. The adaptive beam former processing can obtain a large noise suppression effect by a small number of microphones and is advantageous also in a cost.

However, the adaptive beam former processing technology is disadvantageous in that performance is deteriorated because of that when the coming direction of an actual target signal is different from an assumed coming direction, the target signal is regarded as noise and removed.

In contrast, Japanese Unexamined Patent Application Publication No. 9-9794 proposes a method of suppressing distortion to a target signal by tracking the direction of a speaker by using a plurality of beam formers and correcting the input direction of the beam formers in the direction of the speaker by sequentially detecting the direction of him or her.

However, the noise suppression effect of the adaptive beam former is relatively small to a noise having weak directionality while it has a large noise suppression effect to a noise having strong directionality. In an actual environment of an automobile-navigation system and the like, ambient noise such as driving noise, sounds of horns, the driving noise of other vehicles, and the like are input to the speech recognition engine from various direction. The adaptive beam former has a low noise suppression effect also to high level diffusible noise such as the driving noise arisen while vehicles travel and to noise having a promptly changing sound transmission system such as radiation noise radiated from vehicles traveling at high speed. Further, the adaptive beam former cannot obtain a sufficient suppression performance as to very short noise such as sudden noise which continues during a very short period of time.

### SUMMARY OF THE INVENTION

An object of the present invention is to provide a noise suppression apparatus for speech recognition a target voice emphasis unit, which is supplied with input voice signals from a plurality of channels of a microphone array, which emphasizes a target voice from the input voice signals, and which outputs a target voice emphasis signal; a target voice characteristic vector extraction unit which analyzes the target voice emphasis signal and which calculates a target voice characteristic vector to be subjected to speech recognition; a target voice elimination unit, which is supplied with the input voice signals which eliminates the target voice from the input voices signals and which outputs a target voice elimination signal; a noise characteristic vector extraction unit which analyzes the target voice elimination signal and which calculates a noise characteristic vector; and a degree of multiplexing of noise estimation unit which estimates a degree of multiplexing of noise every predetermined unit time based on the noise characteristic vector and the target voice characteristic vector.

A noise suppression apparatus for speech recognition of the present invention includes a frequency analysis unit which analyzes frequencies of input voice signals from a plurality of channels of a microphone array each channel and which generates input spectrum information from results analyzed frequencies of the input voice signals; a target voice emphasis unit, which emphasizes a target voice component based on the input spectrum information of the plurality of channels and which calculates a target voice spectrum information; a target voice characteristic vector extraction unit which analyzes the target voice spectrum information and which extracts a target voice characteristic vector to be subjected to speech recognition; a target voice elimination unit which eliminates a target voice component based on the input spectrum information of the plurality of channels and which calculates a noise spectrum information; a noise characteristic vector extraction unit which analyzes the noise spectrum information and which extracts a noise characteristic vector; and a degree of multiplexing of noise estimation unit which estimates a degree of multiplexing of noise every predetermined unit time based on the noise characteristic vector and the target voice characteristic vector.

A noise suppression apparatus for speech recognition of the present invention includes a target voice elimination unit, which is supplied with input voice signals from a plurality of channels of a microphone array, which eliminates a target voice from the input voice signals, and which outputs a target voice elimination signal; a noise spectrum information extraction unit which analyzes frequencies of the target voice elimination signal and which calculates a noise spectrum information from results analyzed frequencies of the target voice elimination signal; a target voice emphasis unit, which is supplied with the input voice signals from the plurality of channels, which emphasizes the target voice from the input voice signals, and which outputs a target voice emphasis signal; a target voice spectrum information extraction unit which analyzes frequencies of the target voice emphasis signal and which calculates a target voice spectrum information from results analyzed frequencies of the target voice emphasis signal; and a degree of multiplexing of noise estimation unit which estimates a degree of multiplexing of noise every predetermined unit time based on the noise spectrum information and the target voice spectrum information.

A noise suppression apparatus for speech recognition of the present invention includes a frequency analysis unit which analyzes frequencies of input voice signals from a plurality of channels of a microphone array for each channel; a target voice elimination unit, which is supplied with input spectrum information of the plurality of channels obtained by the frequency analysis unit, which eliminates a target voice component based on the input spectrum information, and which calculates a noise spectrum information from results eliminated the target voice component; a target voice emphasis unit, which is supplied with the input spectrum information of the plurality of channels, which emphasizes the target voice based on the input spectrum information, and which calculates a target voice spectrum information from results emphasized the target voice; and a degree of multiplexing of noise estimation unit for estimates a degree of multiplexing of noise every predetermined unit time based on the target voice spectrum information and the noise spectrum.

A speech recognition apparatus of the present invention includes the noise suppression apparatus for speech recognition; and a target voice characteristic vector check unit which checks the target voice characteristic vector with a recognition dictionary and which adjusts a result of check based on the degree of multiplexing of noise.

A speech recognition apparatus of the present invention includes the noise suppression apparatus for speech recognition; and a target voice characteristic vector check unit which checks the target voice characteristic vector with a recognition dictionary which adjusts a result of check based on the degree of multiplexing of noise.

A speech recognition apparatus of the present invention includes the noise suppression apparatus for speech recognition; and a spectrum information correction unit which corrects the target voice spectrum information so as to eliminate the influence of noise based on the degree of multiplexing of noise.

A speech recognition apparatus of the present invention includes the noise suppression apparatus for speech recognition; and a spectrum information correction unit which corrects the target voice spectrum information so as to eliminate the influence of noise based on the degree of multiplexing of noise.

A noise suppression method for speech recognition according to the present invention includes a step, which is supplied with input voice signals from a plurality of channels of a microphone array, which eliminates a target voice from the input voice signals, and outputs a target voice elimination signal; a noise characteristic vector extraction step which analyzes the target voice elimination signal and calculates a noise characteristic vector; a step, which is supplied with the input voice signals from the plurality of channels, which emphasizes the target voice from the input voice signals, and which outputs a target voice emphasis signal; a target voice characteristic vector extraction step which analyzes the target voice emphasis signal and which calculates a target voice characteristic vector; and a degree of multiplexing of noise estimation step which estimates a degree of multiplexing of noise every predetermined unit time based on the characteristic vector and the target voice characteristic vector.

A noise suppression method for speech recognition according to the present invention includes a frequency analysis step which analyzes frequencies of input voice signals from a plurality of channels of a microphone array each channel and which generates input spectrum information from results analyzed frequencies of the input voice signals; a step, at which the input spectrum information of the plurality of channels is supplied, which emphasizes a target voice input spectrum information and which calculates the spectrum information of the target voice; a target voice characteristic vector extraction step which analyzes the target voice spectrum information and extracting a target voice characteristic vector to be subjected to speech recognition; a target voice elimination step which eliminates a target voice component included in the input spectrum information based on the input spectrum information of the plurality of channels and which calculates the noise spectrum information; a noise characteristic vector extraction step which analyzes the noise spectrum information and which extracts a noise characteristic vector; and a degree of multiplexing of noise estimation step which estimates a degree of multiplexing of noise each characteristic vector component and as to each unit time based on the noise characteristic vector and the target voice characteristic vector A speech recognition method according to the present invention includes the respective steps of a noise suppression method for speech recognition according to claim 33; and a spectrum information correction step which corrects the target voice spectrum information so as to eliminate the influence of noise based on the degree of multiplexing of noise.

A noise suppression method for speech recognition according to the present invention includes a frequency analysis step which analyzes the frequencies of input voice signals of a plurality of channels of a microphone array for each channel; a step, which is supplied with the input spectrum information from the plurality of channels, which emphasizes a target voice input spectrum information and for calculating the spectrum information of the target voice; a target voice characteristic vector extraction step which analyzes the target voice spectrum information and which extracts a target voice characteristic vector to be subjected to speech recognition; a target voice elimination step of eliminating a target voice component based on the input spectrum information of the plurality of channels and which calculates the noise spectrum information; a noise characteristic vector extraction step which analyzes the noise spectrum information and which extracts a noise characteristic vector; a degree of multiplexing of noise estimation step which estimates a degree of multiplexing of noise each characteristic vector component and as to each unit time based on the noise characteristic vector obtained by the noise characteristic vector extraction step and on the target voice characteristic vector obtained by the target voice characteristic vector extraction step; and a characteristic vector correction control step which determines whether or not it is possible to correct the target voice characteristic vector depending upon whether or not the number of components of the target voice characteristic vector, in which the degrees of multiplexing of noise thereof exceed a predetermined threshold value, of all the number of components of the target voice characteristic vector exceeds a predetermined ratio.

A product of a noise suppression program for speech recognition according to the present invention includes for causing a computer to execute: processing, in which input voice signals of a plurality of channels of a microphone array are supplied, for eliminating a target voice and outputting a target voice eliminated signal; processing for analyzing the frequency of the target voice elimination signal and which calculates the spectrum information of a noise component; processing, in which the input voice signals of the plurality of channels are supplied, which emphasizes the target voice from the input signals and which outputs a target voice emphasis signal; target voice spectrum information extraction processing for analyzing the frequency of the target voice emphasized signal and calculating the spectrum information of the target voice; and degree of multiplexing of noise estimation processing which estimates a degree of multiplexing of noise every predetermined unit time based on the spectrum information of the noise component and on the spectrum information of the target voice.

A product of a speech recognition program according to the present invention includes for causing a computer to execute: the respective steps of the processing of the product of the noise suppression program for speech recognition according to claim 36; and spectrum information correction processing which corrects the target voice spectrum information so as to eliminate the influence of noise based on the degree of multiplexing of noise estimated by the degree of multiplexing of noise.

The above and other objects, features and advantages of the invention will become more clearly understood from the following description referring to the accompanying drawings.

### BRIEF DESCRIPTION OF THE DRAWINGS

FIG. 1 is a block diagram showing a noise suppression apparatus for obtaining a voice output in which noise is suppressed to an input signal of a channel 1 by employing a spectrum subtraction technology as a noise suppression technology;

FIG. 2 is a block diagram showing a noise suppression apparatus for speech recognition according to a first embodiment of the present invention;

FIG. 3 is a block diagram showing a specific arrangement of a target voice elimination unit 13 in FIG. 2;

FIG. 4 is a block diagram showing a specific arrangement of a target voice emphasis unit 14 in FIG. 2;

FIG. 5 is a flowchart explaining operation of the first embodiment;

FIG. 6 is a block diagram showing another arrangement of the target voice elimination unit;

FIG. 7 is a block diagram showing an arrangement of a spectrum information correction unit 34 employing a cluster system;

FIG. 8 is a block diagram showing a second embodiment of the present invention;

FIG. 9 is a block diagram showing specific arrangements of a frequency analysis unit 41 and a target voice elimination unit 42 in FIG. 8;

FIG. 10 is a flowchart explaining operation of the second embodiment;

FIG. 11 is a block diagram showing another arrangement of the target voice elimination unit employed in the second embodiment;

FIG. 12 is a block diagram showing a third embodiment of the present invention;

FIG. 13 is a graph explaining operation of the third embodiment;

FIG. 14 is a block diagram showing a fourth embodiment of the present invention;

FIG. 15 is a block diagram showing a fifth embodiment of the present invention; and

FIG. 16 is a flowchart explaining operation of the fifth embodiment.

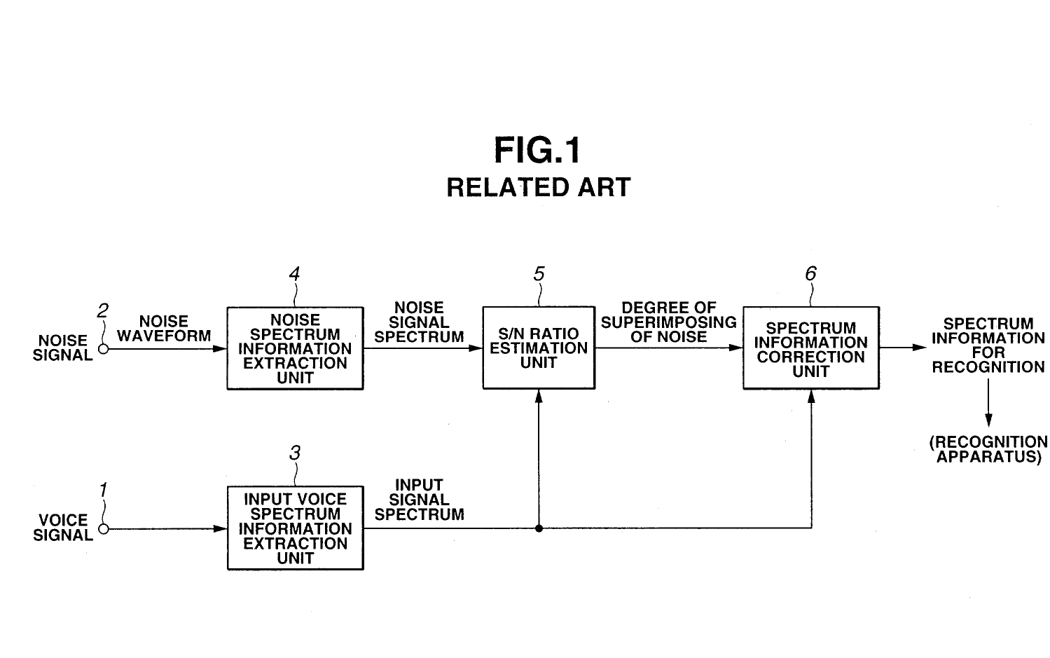

### DETAILED DESCRIPTION OF EMBODIMENTS OF THE INVENTION

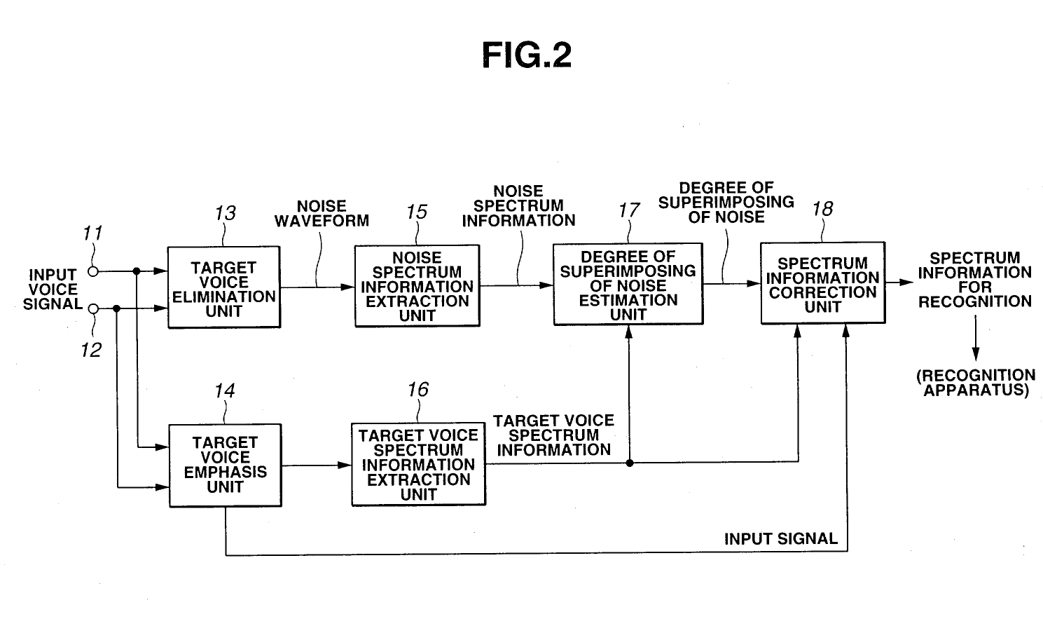

Embodiments of the present invention will be described below in detail with reference to the drawings. FIG. 2 is a block diagram showing a noise suppression apparatus for speech recognition according to a first embodiment of the present invention.

This embodiment suppresses noise when a voice is recognized making use of microphone array processing executed by an adaptive beam former and the like. As described above, the adaptive beam former is sufficiently effective in the suppression of a voice coming from a stable sound source such as a voice produced by a person, while it is less effective in the suppression of noise such as sudden noise and the like.

Thus, in this embodiment, a signal containing only noise is obtained by suppressing a produced voice as a target by the microphone array processing, and the position and the superimposed amount of noise with respect to an input signal are estimated by comparing the signal containing only noise with the signals input from microphones.

The embodiment executes a spectrum information extraction/correction processing in a time region. In FIG. 2, voice signals from microphones disposed at positions spaced apart from each other at a predetermined interval are input to input terminals 11 and 12 directly or through a predetermined communication path.

The voice signals input through the input terminals 11 and 12 are supplied to a target voice elimination unit 13 and to a target voice emphasis unit 14. The target voice elimination unit 13 regards a target voice as noise by a Griffith-Jim adaptive beam former and the like in a time region as a known means and eliminates the target voice.

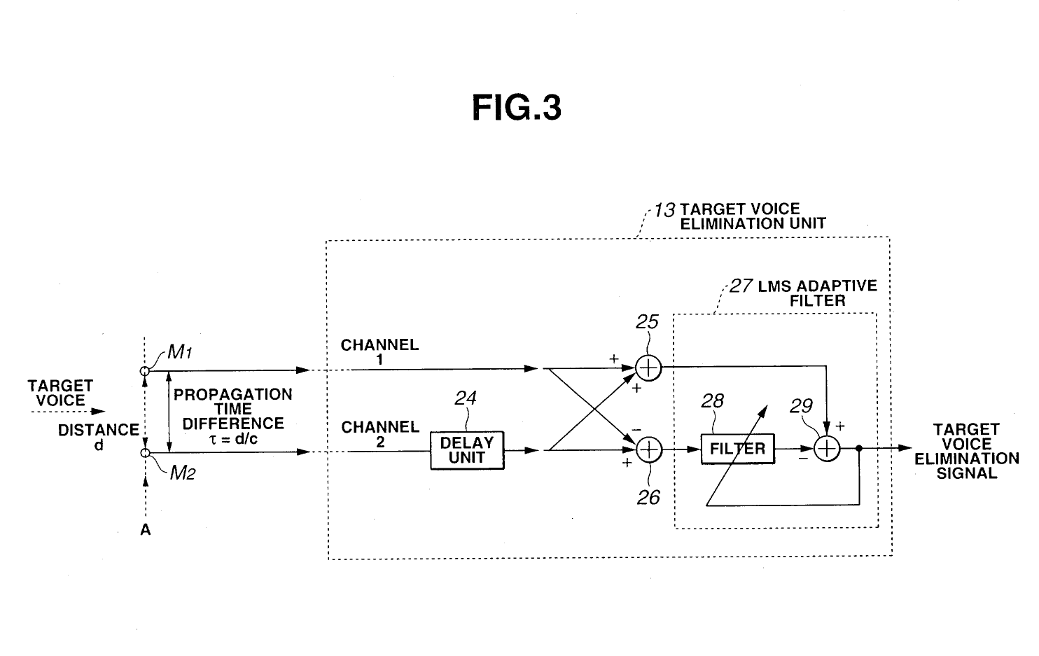

FIG. 3 is a block diagram showing a specific arrangement of the target voice elimination unit 13 in FIG. 2. FIG. 3 shows an example which employs the Griffith-Jim beam former as the adaptive beam former using an LMS adaptive filter in the time region.

In FIG. 3, a microphone array has two microphones M1 and M2 disposed perpendicularly to the coming direction of the target voice. The microphones M1 and M2 are spaced apart from each other by an interval d, and a propagation time difference τ=d/c as to a voice coming from a direction perpendicular to the direction from which the target voice comes (direction A in FIG. 3). Here, c shows a sound velocity.

The two microphones M1 and M2 spaced from each other by, for example, 12 cm are employed as the microphone array, and signals obtained by sampling the outputs from the microphones M1 and M2 at a sampling rate of, for example, 11 kHz is output to the target voice elimination unit 13. Note that the outputs from the microphone may be transmitted through a predetermined communication path and supplied to the target voice elimination unit 13.

The output of the microphone M1 is supplied to adders 25 and 26, and the output of the microphone M2 is supplied to the adders 25 and 26 through a delay unit 24. The delay unit 24 delays the output of the microphone M2 (channel 2) such that the waveforms of the outputs from the respective microphones M1 and M2 are in agreement with (in phase with) the waveform of a voice coming from a direction greatly dislocated from the direction from which the target voice comes, for example, the direction A of FIG. 3.

For example, as shown in FIG. 3, it is assumed that the target voice comes from a direction perpendicular to the direction in which the microphones M1 and M2 are disposed (direction A). In this case, for example, when the waveforms of the outputs from the microphones M1 and M2 are to be in agreement with the waveform of the voice coming from the direction A dislocated 90° with respect to the target voice coming direction, the delay time of the delay unit 24 is set to τ. Note that when the waveforms of the outputs from the microphones M1 and M2 are to be in agreement with the waveform of a voice coming from a direction dislocated by α radian to the target voice coming direction, the delay time τ of the delay unit 24 is set to τ=(d·sin α)/c.

As a result, it can be regarded that the voice coming from the direction A equivalently and simultaneously reaches the two-channel microphones M1 and M2. That is, the voice coming from the direction A is input to the adders 25 and 26 in phase. The voice coming from the direction A is set as a subject to be input by the delay unit 24. Note that the target voice of FIG. 3 is input to the adders 25 and 26 as signals whose phase are dislocated by 90°.

The adder 25 adds the two inputs to thereby calculate the power component of a signal which is double the voice as the subject to be input (the voice coming from the direction A) and the power components of other voice signals. Further, the adder 26 executes subtraction between the two inputs to thereby cancel the voice of the subject to be input and calculate the power component of the target voice.

An LMS adaptive filter 27 is composed of a filter 28 and an adder 29. The filter 28 filtrates the output of the adder 26 and supplies the filtrated output to the adder 29. The adder 29 subtracts the output of the filter 28 from the output of the adder 25. The output of the adder 29 is fed back to the filter 28, and the filter coefficient of the filter 28 sequentially changes to minimize the output of the adder 29.

With this operation, the target voice is reliably eliminated from the target voice elimination unit 13, and target voice elimination signal containing only a noise component N′ is output therefrom.

Note that various beam formers such as a Frost beam former and the like may be used as the adaptive beam former constituting the target voice elimination unit 13, in addition to a generalized sidelobe canceller (GSC).

In contrast, the target voice emphasis unit 14 emphasizes (extracts) the target voice and outputs the emphasized target voice. A Griffith-Jim beam former similarly to that of the target voice elimination unit 13 may be used as the target voice emphasis unit 14.

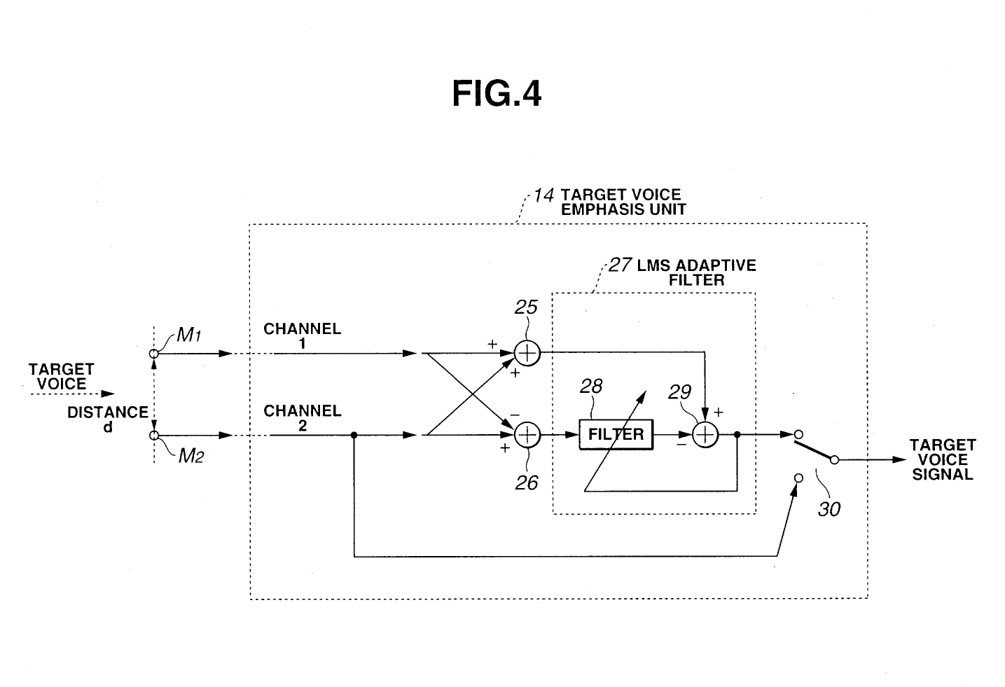

FIG. 4 is a block diagram showing a specific arrangement of the target voice emphasis unit 14 in FIG. 2 and shows an example using the Griffith-Jim beam former. In FIG. 4, the same components as those in FIG. 3 are denoted by the same reference numerals and the description thereof is omitted.

The target voice emphasis unit 14 of FIG. 4 is different from the target voice elimination unit 13 of FIG. 3 only in that the delay unit 24 is removed from the target voice elimination unit 13 as well as a switch 30 is added. That is, a subject to be input to the target voice emphasis unit 14 is a signal in the direction of the target voice. Accordingly, the power component of a signal obtained by doubling the target voice and the power component of a signal coming from other direction are output from the adder 25. Further, the signal from the other coming direction output from the adder 26 is filtered by the filter 28 and supplied to the adder 29.

The LMS adaptive filter 27 changes its filter coefficient to minimize the output therefrom. That is, the signal coming from the other direction is subtracted from the output (target voice) of the adder 25 to thereby maximize the output of the filter 28 (the signal coming from the other direction). With this operation, a target voice signal in which noise is canceled in a maximum amount is output from the LMS adaptive filter 27. The switch 30 selectively outputs the target voice from the LMS adaptive filter 27 and the output of the microphone M2.

With the above operation, the target signal voice in which noise is suppressed to some extent is output together with a noise component N.

Note that any one of the signals of the two microphones M1 and M2 may be used as it is as the output of the target voice emphasis unit 14. While it is permitted to output the output (channel 2) from the microphone M2 in the example of FIG. 4, the output of the channel 1 from the microphone M1 may be output.

The output of the target voice elimination unit 13 and the output of the target voice emphasis unit 14 are supplied to a noise spectrum information extraction unit 15 or to a target voice spectrum information extraction unit 16, respectively. The noise spectrum information extraction unit 15 calculates noise spectrum information from the signal (noise signal) input thereto. In contrast, the noise spectrum information extraction unit 16 calculates target voice spectrum information from the signal (target voice signal) input thereto.

For example, the target voice elimination unit 13 and the target voice emphasis unit 14 analyze the frequency of an input voice with respect to a plurality of predetermined frequency bands and obtains a result of analysis of the respective frequency bands as spectrum information which is a characteristic amount (characteristic vector). The spectrum information is determined in a unit of a fixed time length called a frame, and the target voice elimination unit 13 and the target voice emphasis unit 14 obtain a time series of the spectrum information (a time series of the characteristic amount (a time series of the characteristic vector)) in a voice zone. The time series of the noise spectrum information and the target voice spectrum information extracted by the target voice elimination unit 13 and the target voice emphasis unit 14 is supplied to a degree of multiplexing of noise estimation unit 17.

The noise spectrum information extraction unit 15 and the target voice spectrum information extraction unit 16 may extract vector information from an FFT spectrum or may use the output of a band-pass filter bank. When the FFT spectrum is used, a window length is set to, for example, 256 points, and a time window is composed of a humming window.

The degree of multiplexing of noise estimation unit 17 compares the noise spectrum information with the target voice spectrum and calculates a degree of multiplexing of noise. The degree of multiplexing of noise estimation unit 17 determines the degree of multiplexing of noise such that a degree of multiplexing of noise containing no noise component is set to “0” and a degree of multiplexing of noise containing only a noise component is set to “1”.

When the adaptive beam former is employed as the target voice elimination unit 13 and the target voice emphasis unit 14, the target voice component S and the noise component N are included in the target voice spectrum information, and the noise component N′ is included in the noise spectrum information, as described above.

When the powers of a k-th band of the target voice spectrum information and the noise spectrum information are shown by Pa(k) and Pb(k), Pa(k)=S(k)+N(k), Pb(k)=N′(k).

For example, the degree of multiplexing of noise estimation unit 17 defines the degree of multiplexing of noise Z(k) as to the k-th band by the following expression (1).

Z(k)=(Pa(k)−Pb(k))/Pa(k) (1)

Since it can be regarded that the power of the noise component N is approximately equal to the power of the noise component N′, the degree of multiplexing of noise Z(k) can be represented by the following expression (2).

Z(k)=1−(S(k)+N(k)−N′(k))/(S(k )+N (k )) (2)

In this case, 0≦Z(k)≦1.

The degree of multiplexing of noise estimation unit 17 calculates the degree of multiplexing of noise Z of each frame as to all the bands. The degree of multiplexing of noise estimation unit 17 outputs the thus calculated degree of multiplexing of noise Z to a spectrum information correction unit 18.

The spectrum information correction unit 18 is supplied with the output of the target voice emphasis unit 14 and corrects the spectrum component of the target voice spectrum information based on the degree of multiplexing of noise input thereto so that the spectrum component is less influenced by noise. The spectrum information correction unit 18 outputs the corrected target voice spectrum information to a speech recognition engine (not shown) as speech recognition spectrum information.

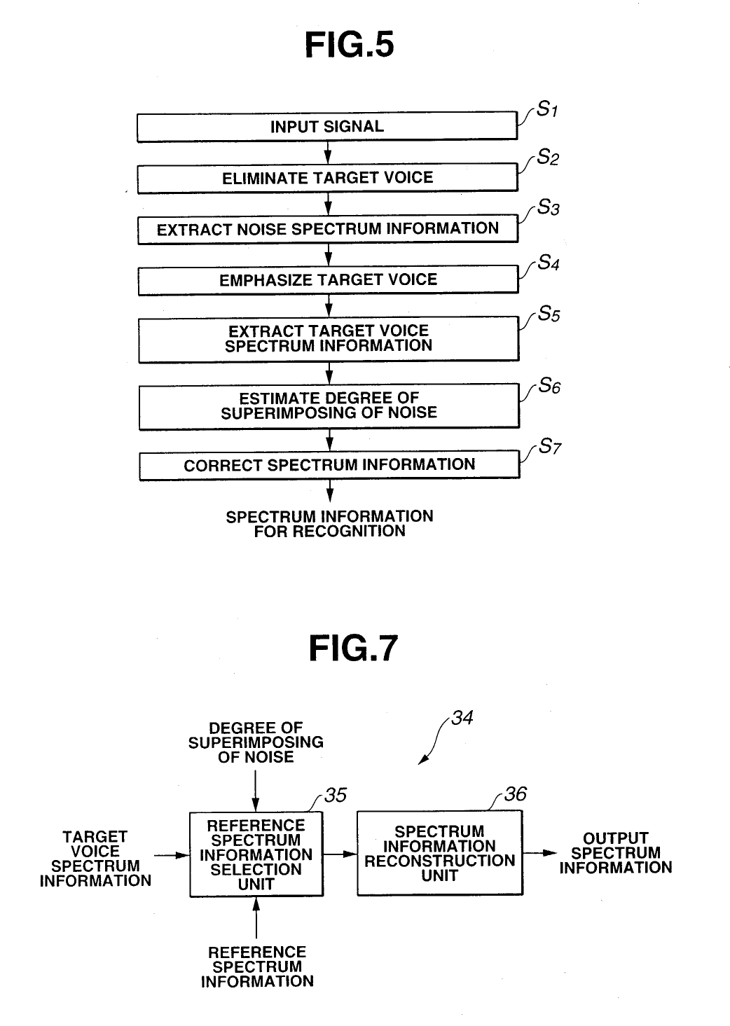

Next, operation of the embodiment arranged as described above will be described with reference to a flowchart of FIG. 5. FIG. 5 shows processing steps executed in one frame period, and the flow of FIG. 5 is executed in all the frames.

First, signals are input at step S1 of FIG. 5. A target voice and other coming voice are input to the microphones M1 and M2 constituting the microphone array. Note that the target voice comes to the microphones M1 and M2 from the direction perpendicular to the direction in which the microphones M1 and M2 are disposed.

In this embodiment, noise is not suppressed but the target voice is suppressed by microphone array processing. That is, at step S2 of FIG. 5, the target voice elimination unit 13 suppresses the target voice, obtains a noise signal from which the target voice is eliminated, and outputs the noise signal to the noise spectrum information extraction unit 15.

The target voice such as a voice produced by a user, and the like is generally a signal having a relatively strong level as well as has high directionality, and continues for a relatively long period of time. Accordingly, the microphone array processing can very effectively suppress the target voice, thereby an output, in which the target voice is sufficiently suppressed, that is, a noise component, which comes from a direction different from the direction of the target voice, can be obtained. The noise spectrum information extraction unit 15 determines spectrum information (noise spectrum information) as to all the bands of each frame with respect to the output of the target voice elimination unit 13 (step S3).

In contrast, at step S4 of FIG. 5, the target voice emphasis unit 14 suppresses the noise component in the direction-other than the target voice coming direction, obtains the target voice from which the noise component is eliminated, and outputs the target voice to the target voice spectrum information extraction unit 16. In this case, since the direction from which the noise component comes is not fixed and further the noise component has a weak level, a sufficient noise suppression effect cannot be obtained as to the noise component. Thus, the output of the target voice emphasis unit 14 contains a relatively large amount of the noise component.

At next step S5, the target voice spectrum information extraction unit 16 extracts the spectrum information of the target voice. The noise spectrum information and the target voice spectrum information having been extracted are supplied to the degree of multiplexing of noise estimation unit 17. The degree of multiplexing of noise estimation unit 17 determines the degree of multiplexing of noise of, for example, the above expression (2) at step S6.

The spectrum information correction unit 18 corrects the target voice spectrum information from the input signal and the target voice spectrum information based on the degree of multiplexing of noise having been input(step S7). The corrected target voice spectrum information is output to the speech recognition engine (not shown) as the speech recognition spectrum information.

As described above, in the embodiment, the target voice is eliminated by the microphone array, and the signal containing only noise is obtained. Then, a position where an S/N ratio is low is specified based on the noise component obtained by eliminating the target voice and on the signals input to the microphones, and a recognition characteristic amount is corrected based on the specified position. That is, even in noise environments in which sufficient noise suppression effect cannot be obtained, a portion where the S/N ratio is low is prevented from being output to the speech recognition engine as it is, thereby speech recognition having high noise resistance can be realized by suppressing the occurrence of erroneous recognition, which would be caused by recognizing a characteristic amount in which the characteristics of a voice are lost by noise, as it is.

Note that there is also contemplated a method of collecting the noise signal and the target voice signal by different microphones and estimating the degree of multiplexing of noise in the voice signal similarly to this embodiment. In this case, however, the microphone for collecting only noise must be disposed at a spaced-apart position so that the target voice is not mixed with the noise signal or must be provided with strong directivity.

Further, since the signal from the microphone to which a voice is input and the signal from the microphone to which noise is input must contain noise similarly, the distance between the two microphones cannot be increased. Accordingly, it is not advantageous to use the two microphones to input a voice and noise separately.

Further, while the embodiment describes an example for processing the signals input from the two microphones through two channels, it is apparent that the embodiment is also applicable to processing in which the signals are input through three or more channels.

Further, while the degree of multiplexing of noise estimation unit 17 calculates the degree of multiplexing of noise as to each frequency band, the degree of multiplexing of noises estimation unit 17 may calculate it regarding all the frequency bands as on frequency band without dividing them.

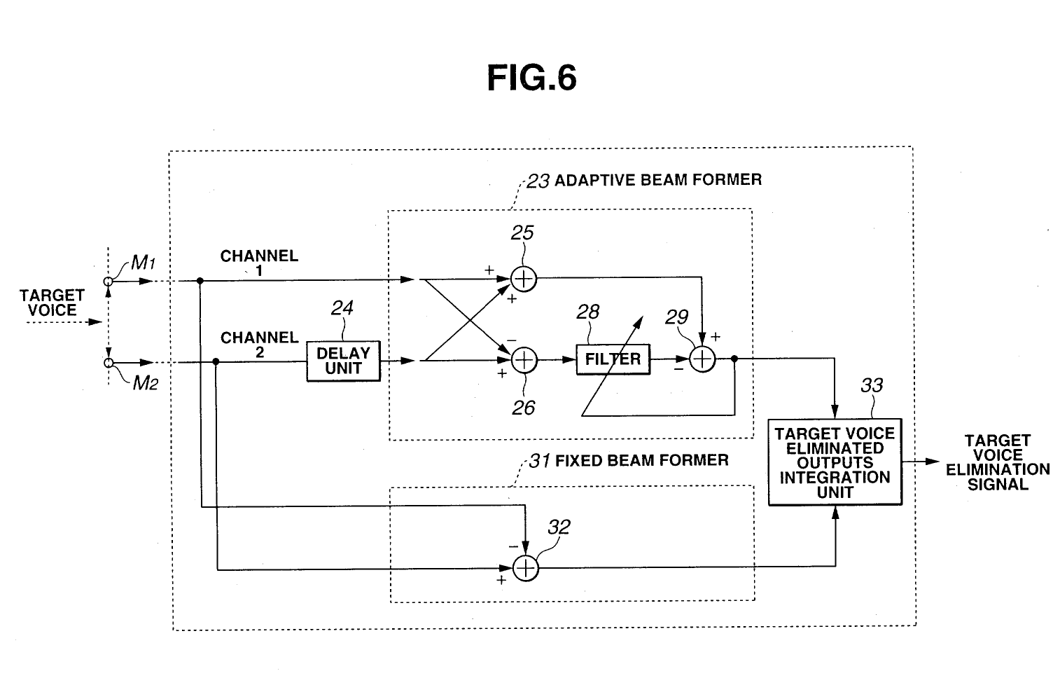

FIG. 6 is a block diagram showing another arrangement of the target voice elimination unit.

As shown in FIG. 6, the target voice elimination unit may be arranged by combining an adaptive beam former 23 having the same arrangement as that of FIG. 3 with a fixed beam former 31. While the adaptive beam former 23 can excellently eliminate a target voice even if a position of the user is dislocated from the direction of the target voice when the position is viewed from a microphone, the elimination effect of the adaptive beam former 23 is deteriorated when the S/N ratio is low.

In contrast, the fixed beam former 31 is composed of an adder 32. When the position of the user is dislocated from the direction of the target voice, the elimination effect thereof is reduced. However, when the position is not dislocated, the fixed beam former 31 can achieve a high elimination effect even if the S/N ratio is low. Thus, a high elimination effect can be obtained even if the position of the user is dislocated from the direction of the target voice or even if the S/N ratio is low when the adaptive beam former 23 is used in parallel with the fixed beam former 31 and the outputs from the respective adaptive beam formers 23 and 31 are integrated by a target voice eliminated outputs integration unit 33.

As a method of integration processing executed by the target voice eliminated outputs integration unit 33, when the integration processing is executed in the time region, output powers may be calculated with respect to the outputs of both the beam formers 23 and 31 for a predetermined short time as to, for example, each zone of an entire processing frame and compared with each other, and a power having a smaller waveform may be output from the target voice elimination unit.

Note that when the integration processing is executed in a frequency region, the output powers may be calculated with respect to the outputs from both the beam formers 23 and 31 as to each frequency band and compared with each other, and a band component having a relatively small power may be output from the target voice elimination unit.

Further, while various methods are contemplated as a processing method executed by the fixed beam former, a simple difference between channels may be used as shown in FIG. 6.

Further, it is apparent that the target voice emphasis unit 14 may be also composed of a combination of the adaptive beam former and the fixed beam former.

Incidentally, various methods are contemplated as a method of correcting the target voice spectrum of the spectrum information correction unit 18 of FIG. 2. For example, a cluster method may be employed which subjects the target voice spectrum information to clustering and replaces it with clear voice data.

FIG. 7 is a block diagram showing an arrangement of a spectrum information correction unit 34 employing the cluster method.

The spectrum information correction unit 34 stores reference spectrum information in a reference memory (not shown). The reference spectrum information is composed of a plurality of representative spectra which are obtained by clustering a lot of spectrum information obtained by processing clear voice data by the same method as that of the target voice spectrum information. Note that a general K-Means algorithm and the like can be used as the clustering method.

A reference spectrum information selection unit 35 is supplied with the target voice spectrum information from the target voice spectrum information extraction unit 16, with the degree of multiplexing of noise from the degree of multiplexing of noise estimation unit 17, and with the reference spectrum information from the reference memory. The reference spectrum information selection unit 35 checks the reference spectrum information against the target voice spectrum information and selects reference spectrum information nearest to the target voice spectrum information from the reference spectra. Note that an inter-vector distance of the characteristic vectors can be used as a criterion of selection.

The reference spectrum information selection unit 35 selects a suitable selection method based on a degree of multiplexing of noise. For example, when the degree of multiplexing of noise of a predetermined frame is lower than a predetermined threshold value, the reference spectrum information selection unit 35 ignores the component of the target voice spectrum information having been input when it is checked. Otherwise, the reference spectrum information selection unit 35 may adjust a weight used in the check as to each component of the target voice spectrum information based on the degree of multiplexing of noise.

For example, when the reference spectrum information of a k-th band is shown by S(k), the reference spectrum information selection unit 35 determines the inter-vector distance R between S(k) and the target voice spectrum information Pa(k) by the following expression (3) using the degree of multiplexing of noise Z(k).

$$R = {\sum }_{k = 1}^{N} ( P a ( k ) - S ( k ) ) * Z ( k ) \qquad ( 3 )$$

where, N shows the total number of bands.

A spectrum information reconstruction unit 36 corrects the target voice spectrum information using the reference spectrum information nearest to the target voice spectrum information. For example, the spectrum information reconstruction unit 36 updates the target voice spectrum information using the following expression (4).

$$\begin{matrix}P a ( k ) = P a ( k ) * Z ( k ) - S ( k ) ( 1 - Z ( k ) ) \\ = P a ( k ) * ( 1 - Z ( k ) ) + S ( k ) Z ( k )\end{matrix} \qquad ( 4 )$$

As described above, speech recognition accuracy can be greatly improved by replacing extracted target voice spectrum information with reference spectrum information with which no noise is mixed when, for example, noise is relatively small by making use of that the degree of multiplexing of noise of the extracted target voice spectrum information of a predetermined frame can be grasped by the degree of multiplexing of noise Z(k).

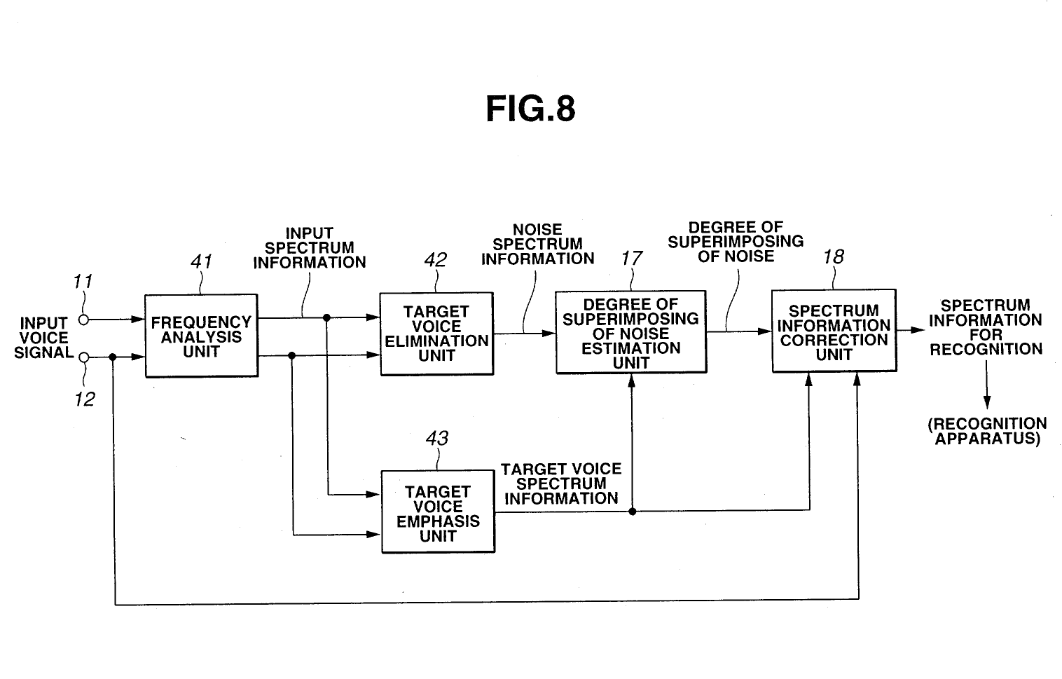

FIG. 8 is a block diagram showing a second embodiment of the present invention. In FIG. 8, the same components as those in FIG. 2 are denoted by the same reference numerals and the description thereof is omitted.

In the example described in the first embodiment, the target voice is eliminated and emphasized in the time region. In contrast, in the second embodiment, the target voice is eliminated and emphasized in a frequency region.

The second embodiment is different from the first embodiment in that a frequency analysis unit 41 is added as well as a target voice elimination unit 42 and a target voice emphasis unit 43 are employed in place of the target voice elimination unit 13 and the target voice emphasis unit 14 respectively.

The frequency analysis unit 41 analyzes the frequencies of the input signals input through input terminals 11 and 12 and outputs a result of analysis to the target voice elimination unit 42 and to the target voice emphasis unit 43.

The target voice elimination unit 42 can be composed of a Griffith-Jim adaptive beam former and the like using a known frequency region adaptive filter (FLMS adaptive filter) 50. The target voice elimination unit 42 regards a target voice as noise and eliminates the target voice and outputs noise spectrum information similarly to the target voice elimination unit 13 of the first embodiment. Further, the target voice elimination unit 43 extracts the target voice by eliminating noise to some extent and outputs target voice spectrum information similarly to the target voice emphasis unit 14 in the first embodiment.

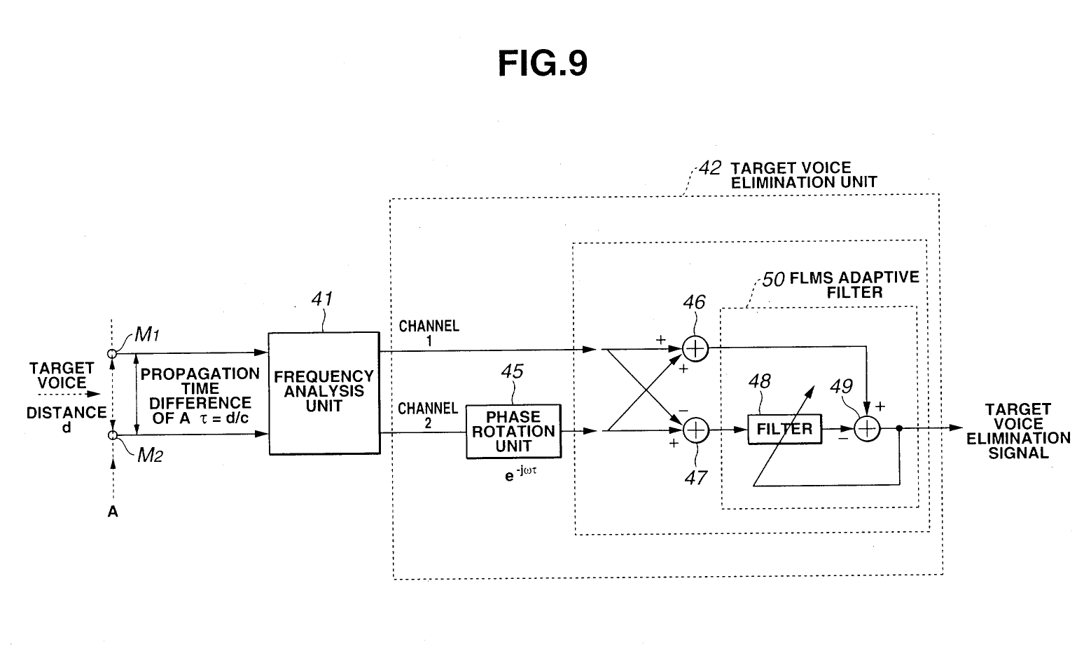

FIG. 9 is a block diagram showing specific arrangements of the frequency analysis unit 41 and the target voice elimination unit 42 in FIG. 8.

The target voice elimination unit 42 is different from the target voice elimination unit 13 of FIG. 3 only in that the target voice elimination unit 13 is operated in the frequency region. The signals of a microphone array is transmitted to the frequency analysis unit 41 directly from microphones M1 and M2 constituting the microphone array or through a predetermined communication path. The microphone array is arranged similarly to that of FIG. 3. Note that while FIG. 9 shows an example in which the signals are input through two channels, it is apparent that they may be input through three or more channels similarly.

The frequency analysis unit 41 analyzes the frequencies of the input signals of the respective channels as to each channel. An FFT may be employed as the frequency analysis unit 41, and further a band-pass filter may be used as the frequency analysis unit 41.

The output of the channel 1 from the frequency analysis unit 41 is supplied to an adder 46, and the output of the channel 2 is supplied to a phase rotation unit 45. The phase rotation unit 45 phase rotates the output of the microphone M2 (channel 2) such that the output waveforms of the respective microphones M1 and M2 are in agreement with (in phase with) the waveform of a voice coming from a direction greatly dislocated from the direction from which the target voice comes, for example, the direction A of FIG. 3.

For example, as shown in FIG. 3, it is assumed that the target voice comes from a direction perpendicular to the direction in which the microphones M1 and M2 are disposed (direction A). In this case when it is indented to agree the waveforms of the outputs of the microphones M1 and M2 with, for example, the waveform of the voice coming from the direction A which dislocates by 90° to the target voice coming direction, the amount of phase rotation of the phase rotation unit 45 is set e^{(-jωτ)} which corresponds to a propagation time difference τ between the microphones M1 and M2.

As a result, it can be regarded that the voice coming from the direction A equivalently and simultaneously reaches the two-channel microphones M1 and M2. That is, the voice coming from the direction A is input to the adder 46 and an adder 47 in phase. The adder 46 adds the two inputs to thereby calculate the power component of a signal, which is double the voice as a subject to be input (the voice coming from the direction A), and the power component of other voice signal. Further, the adder 47 executes subtraction between the two inputs to thereby cancel the voice of the subject to be input and calculates the power component of the target voice.

The FLMS adaptive filter 50 is composed of a filter 48 and an adder 49. The filter 48 filtrates the output from the adder 47 and supplies it to the adder 49. The adder 49 subtracts the output of the filter 48 from the output of the adder 46. The output of the adder 49 is fed back to the filter 48, and the filter coefficient of the filter 48 sequentially changes to minimize the output of the adder 49.

That is, the target voice elimination unit 42 of FIG. 9 is different from the target voice elimination unit 13 of FIG. 3 only in that it operates in the frequency region. Thus, the target voice elimination unit 42 eliminates the target voice and outputs a target voice eliminated signal containing only a noise component N′.

In contrast, the target voice emphasis unit 43 can be also composed of a Griffith-Jim adaptive beam former and the like similarly to the target voice elimination unit 42. In this case, the target voice emphasis unit 43 is different from the target voice elimination unit 42 only in that the phase rotation unit 45 is omitted as well as a switch corresponding to the switch 30 of FIG. 4 is provided. With the above arrangement, a target voice signal, in which noise is suppressed to some extent, is output from the target emphasis unit 43 together with a noise component N.

The outputs of the target voice elimination unit 42 and the target voice emphasis unit 43 are already spectrum information and thus supplied to a degree of multiplexing of noise estimation unit 17 as they are.

Other arrangements of the second embodiment are the same as those of the first embodiment of FIG. 2.

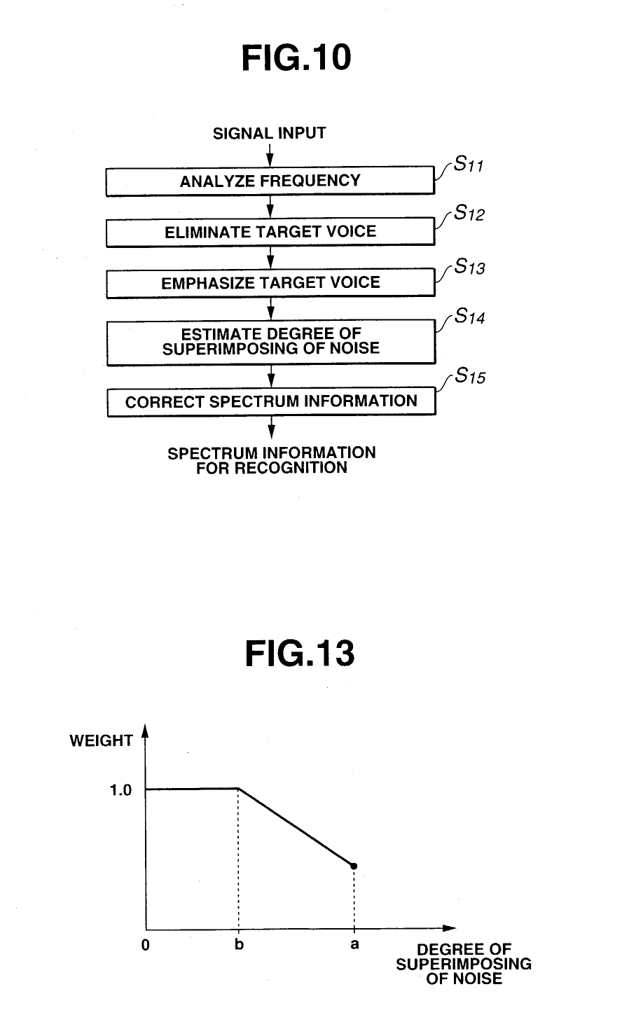

Next, operation of the second embodiment arranged as described above will be described with reference to a flowchart of FIG. 10. FIG. 10 shows processing steps executed in one frame period, and the flow of FIG. 10 is executed for all the frames.

A target voice and other coming voice are input to the microphones M1 and M2 constituting the microphone array. Note that the target voice comes to the microphones M1 and M2 from the direction perpendicular to the direction in which the microphones M1 and M2 are disposed.

In this embodiment, the processing steps are executed in the frequency region. That is, the frequencies of the signals input through the microphones M1 and M2 are analyzed in the frequency analysis unit 41 at step S11 of FIG. 10.

Next, the target voice elimination unit 42 does not suppress noise but suppresses the target voice. That is, at step S12 of FIG. 10, the target voice elimination unit 42 suppresses the target voice and obtains the spectrum information of a noise signal from which the target voice is eliminated. In this case, the target voice such as a voice produced by a user, and the like is generally a signal having a relatively strong level as well as high directionality, and the signal continues for a relatively long period of time. Accordingly, the target voice elimination unit 42 making use of the microphone array can obtain an output in which the target voice is sufficiently suppressed, that is, a noise component which comes from a direction different from the direction of the target voice.

In contrast, the target voice emphasis unit 43 suppresses a noise component in the direction other than the direction from which the target voice comes in the frequency region, obtains the target voice from which the noise component is eliminated to some extent, and outputs the spectrum information of the target voice (step S13). In this case, a sufficient suppression effect cannot be obtained as to the noise component because a direction from which the noise component comes is not fixed and the noise component has a weak level. Thus, the output of the target voice emphasis unit 43 contains a relatively large amount of the noise component.

Processing for estimating a degree of multiplexing of noise executed at the next step S14 and processing for correcting spectrum information executed at step S15 are the same as those executed at steps S6 and S7 of FIG. 5, respectively.

As described above, in the second embodiment, the target voice elimination and emphasis processing can be executed in the frequency region. With this operation, the second embodiment has a benefit in that it can obtain an effect similar to that of the first embodiment and in that it is advantageous in the performance of the beam former and in an amount of calculation.

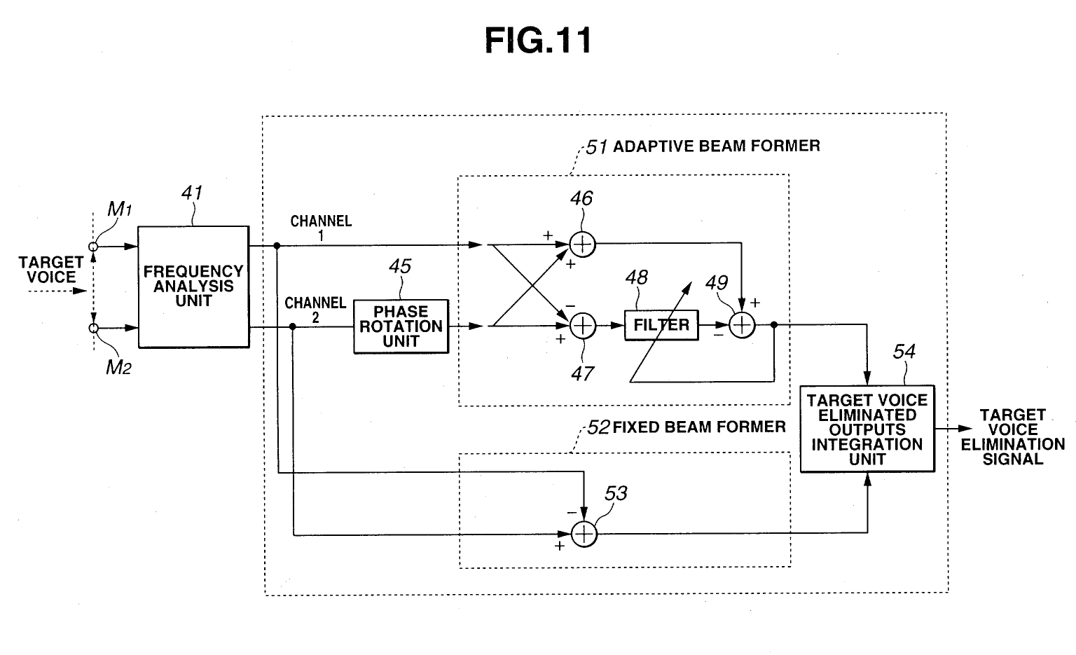

FIG. 11 is a block diagram showing another arrangement of the target voice elimination unit employed in the second embodiment.

As shown in FIG. 11, the target voice elimination unit may be composed of a combination of an adaptive beam former 51 and a fixed beam former 52 each having the same arrangement as that of FIG. 9. While the adaptive beam former 51 can excellently eliminate a target voice even if a position of the user is dislocated from the direction of the target voice when the position is viewed from a microphone, the elimination effect of the adaptive beam former 51 is deteriorated when the S/N ratio is low.

In contrast, the fixed beam former 52 is composed of an adder 53. When the position of the user is dislocated from the direction of the target voice, the elimination effect of the fixed beam former 52 is reduced. However, when the position is not dislocated, the fixed beam former 52 can obtain a high elimination effect even if the S/N ratio is low. Thus, a high elimination effect can be obtained even if the position of the user is dislocated from the direction of the target voice or even if the S/N ratio is low when the adaptive beam former 51 is used in parallel with the fixed beam former 52 and the outputs from the respective adaptive beam formers 51 and 52 are integrated by a target voice eliminated outputs integration unit 54.

As a method of integration processing executed by the target voice eliminated outputs integration unit 54, the output powers may be calculated with respect to the outputs of both the beam formers 51 and 52 as to each frequency band and compared with each other, and a band component having a smaller output power may be output from the target voice elimination unit.

Further, while various methods are contemplated as a processing method executed by the fixed beam former, a simple difference between channels may be used as shown in FIG. 11.

Further, it is apparent that the target voice emphasis unit 43 may be also composed of a combination of the adaptive beam former and the fixed beam former.

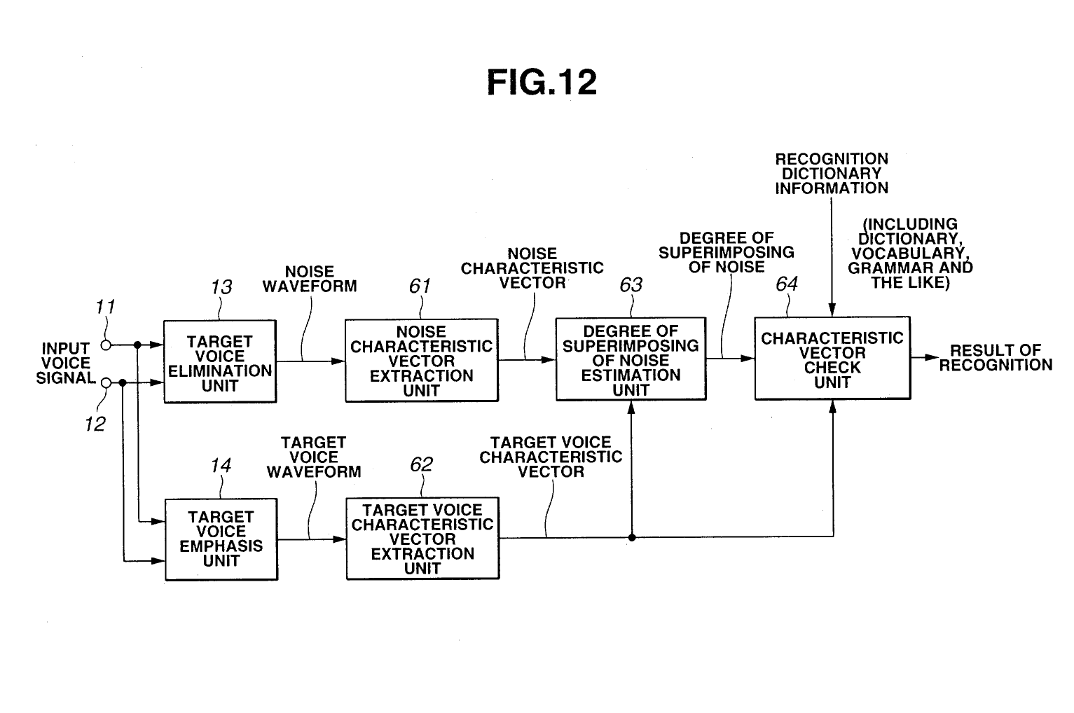

FIG. 12 is a block diagram showing a third embodiment of the present invention. In FIG. 12, the same components as those in FIG. 2 are denoted by the same reference numerals and the description thereof is omitted.

In the first and second embodiments described above, the spectrum information acting as the input to the recognition apparatus is corrected according to a degree of multiplexing of noise. In the third embodiment, however, missing feature processing (refer to the following document 1) is applied when the degree of multiplexing of noise is large and noise is superimposed for a long time over a wide band.

A speech recognition engine compares vocabularies to be recognized, which are created based on phonemic models, with a characteristic amount extracted from an input voice as to each frame and outputs a vocabulary having a numerical value (hereinafter, referred to as “check score”) which is highest as a result of the comparison.

However, when the S/N ratio is relatively large, the check score is less reliable. To cope with this problem, the missing feature processing described in the following document 1 in detail is employed as one of speech recognition methods which are strongly resistant to noise, and the check score is set to, for example, a fixed value as to a frame having a relatively low S/N ratio so that no difference is arisen between the phonemic models. Document 1: Using missing feature theory to actively select features for robust speech recognition with interruptions, filtering, and noise, Proceedings of Eurospeech '97 KN-37, the contents of which are hereby incorporated by reference).

Accordingly, in the missing feature processing, the position of a portion where the S/N ratio is low in a voice signal must be found. A MAP method, which is described in the following document 2 in detail, and the like are available as a method of finding the position of the portion where the S/N ratio is low. However, this method requires learning according to noise environments, processing is complicated, the position may not be found depending on learned data, and the method is not always reliable. Document 2: Reconstruction of damaged spectrographic features for robust speech recognition, Proceedings of ICSLP 2000, pp. 357-360, the contents of which are hereby incorporated by reference.

In contrast, in the first and second embodiments described above, the positions where noise is superimposed in a voice signal and the degrees of multiplexing of the noise can be reliably detected by eliminating a target voice by the microphone array and obtaining a signal containing only noise. Therefore, the reliability of the missing feature processing can be greatly improved by applying the first and second embodiments.

In FIG. 12, the waveform of noise from which the target voice is eliminated definitely is output from the target voice elimination unit 13 and input to a noise characteristic vector extraction unit 61. Further, the waveform of the target voice from which noise is eliminated to some extent is output from the target voice emphasis unit 14 and input to a target voice characteristic vector extraction unit 62.

The noise characteristic vector extraction unit 61 extracts the characteristic vector of noise from the waveform of the noise. Further, the target voice characteristic vector extraction unit 62 extracts the characteristic vector of the target voice from the waveform of the target voice. For example, the noise characteristic vector extraction unit 61 and the target voice characteristic vector extraction unit 62 analyze the frequency of an input voice as to each of a plurality of predetermined frequency bands and obtains a result of analysis as a characteristic vector (characteristic parameter) as to each frequency band. The characteristic vector (characteristic parameter) is determined as to each frame acting as a unit time, and the extraction units 61 and 62 obtain a series of characteristic vectors in a voice zone (a time-series of characteristic vectors).

Note that a power spectrum obtained by a band-pass filter or Fourier transformation, a cepstrum coefficient determined by an LPC (linear predictive coding) analysis, and the like are well known as a typical characteristic vector used for speech recognition. In this embodiment, however, any type of a characteristic vector may be used.

The noise characteristic vector from the noise characteristic vector extraction unit 61 and the target voice characteristic vector from the target voice characteristic vector extraction unit 62 are supplied to a degree of multiplexing of noise estimation unit 63. The degree of multiplexing of noise estimation unit 63 calculates a degree of multiplexing of noise, which is a superimposing degree of noise, from the noise characteristic vector as to each vector component. Note that the degree of multiplexing of noise estimation unit 63 employs the same calculation method as that of the first embodiment. The calculated degree of multiplexing of noise is supplied to a characteristic vector check unit 64.

The characteristic vector check unit 64 is also supplied with the target voice characteristic vector. The characteristic vector check unit 64 is supplied with recognition dictionary information including vocabularies to be recognized, grammar, and the like from a recognition dictionary (not shown), checks the pattern of the target voice characteristic vector, and outputs a result of recognition based on the check score.

In this embodiment, the characteristic vector check unit 64 adjusts the check core based on the degree of multiplexing of noise of each frame having been input to thereby improve recognition accuracy.

Next, operation of the embodiment arranged as described above will be described with reference to a graph of FIG. 13. In FIG. 13, a horizontal axis shows a degree of multiplexing of noise and a longitudinal axis shows a weight to be applied to the check score.

The input voice signal is supplied to the target voice elimination unit 13 and to the target voice emphasis unit 14. The target voice is eliminated by the target voice elimination unit 13, and a noise waveform is output. Further, noise is eliminated to some extent by the target voice emphasis unit 14, and a target voice waveform is output. The noise characteristic vector extraction unit 61 extracts a noise characteristic vector, and the target voice characteristic vector extraction unit 62 extracts a target voice characteristic vector. The degree of multiplexing of noise estimation unit 63 calculates the degree of multiplexing of noise of each frame from the noise characteristic vector and the target voice characteristic vector.

The target voice characteristic vector is input to the characteristic vector check unit 64 from the target voice characteristic vector extraction unit 62. The characteristic vector check unit 64 determines the check score of the target voice characteristic vector of each frame using the recognition dictionary information. In this case, the characteristic vector check unit 64 adjusts the check score according to the graph of FIG. 13.

That is, it is assumed now that the S/N ratio is very excellent in a predetermined frame and that the degree of multiplexing of noise is smaller than a predetermined value b. In this case, the check score is very reliable. Thus, the characteristic vector check unit 64 uses the check score as it is (a weight of 1.0 is applied thereto).

Next, it is assumed that the S/N ratio is very bad in the predetermined frame and that the degree of multiplexing of noise is larger than a predetermined value a. In this case, the check score is very unreliable. Thus, the characteristic vector check unit 64 sets the check score to a predetermined given value. In this case, no difference is caused in the check score between a characteristic amount and each phonemic model to be compared. That is, a frame, in which the degree of multiplexing of noise is larger than the predetermined value a, is equivalent to that the frame is not used in speech recognition. This prevents erroneous recognition caused by noise.

Further, it is assumed that the S/N ratio is somewhat bad in the predetermined frame and that the degree of multiplexing of noise has a value between the predetermined values a and b. In this case, it is contemplated that the reliability of the check score changes according to the degree of multiplexing of noise. Thus, the characteristic vector check unit 64 applies a weight to the check score according to the degree of multiplexing of noise. For example, when the degree of multiplexing of noise has a value near to the predetermined value a, a small weight is applied to the check score so that the check score less influences the result of speech recognition in this region. On the contrary, when the degree of multiplexing of noise has a value near to the predetermined value b, a weight near to 1 is applied to the check score so that the check score relatively greatly influences the result of speech recognition in this region.

The characteristic vector check unit 64 obtains the result of speech recognition based on the check score calculated according to the degree of multiplexing of noise.

As described above, in this embodiment, the position of a portion, where the S/N ratio is low, can be detected with reliability using the microphone array which does not suppress noise but suppresses the target voice. Since the position and the magnitude of noise can be reliably detected, the reliability of various missing feature processing steps can be improved and the effect of the missing feature processing is maximized, thereby noise resistance of the speech recognition can be greatly improved.

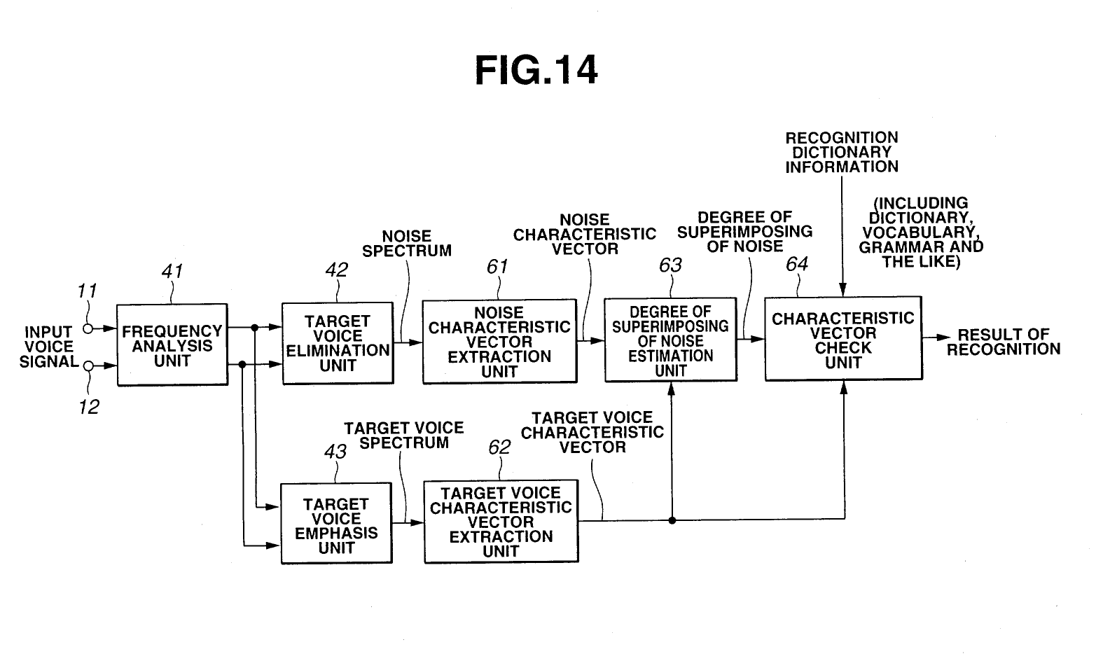

FIG. 14 is a block diagram showing a fourth embodiment of the present invention. In FIG. 14, the same components as those in FIGS. 8 and 12 are denoted by the same reference numerals and the description thereof is omitted.

In the example described in the third embodiment, the target voice is eliminated and emphasized in the time region. In contrast, in the fourth embodiment, the target voice is eliminated and emphasized in a frequency region.

The fourth embodiment is different from the first embodiment in that a frequency analysis unit 41 is added as well as a target voice elimination unit 42 and a target voice emphasis unit 43 are employed in place of the target voice elimination unit 13 and the target voice emphasis unit 14.

Other arrangements and operations are the same as those of the embodiments of FIGS. 7 and 12.

Note that when a characteristic vector is calculated, various parameters can be employed such as a power spectrum obtained by a band-pass filter or Fourier transformation, a cepstrum coefficient determined by an LPC (linear predictive coding) analysis, and the like. However, a parameter, which is directly determined from a wavenumber spectrum without being returned to a time waveform, can be conveniently used.

The fourth embodiment can also obtain the same effect as that of the third embodiment as well as has a benefit in that it is advantageous in an amount of calculation, which is necessary to eliminate and emphasize a target voice, and a performance as compared with a case in which the target voice is processed in the time region.

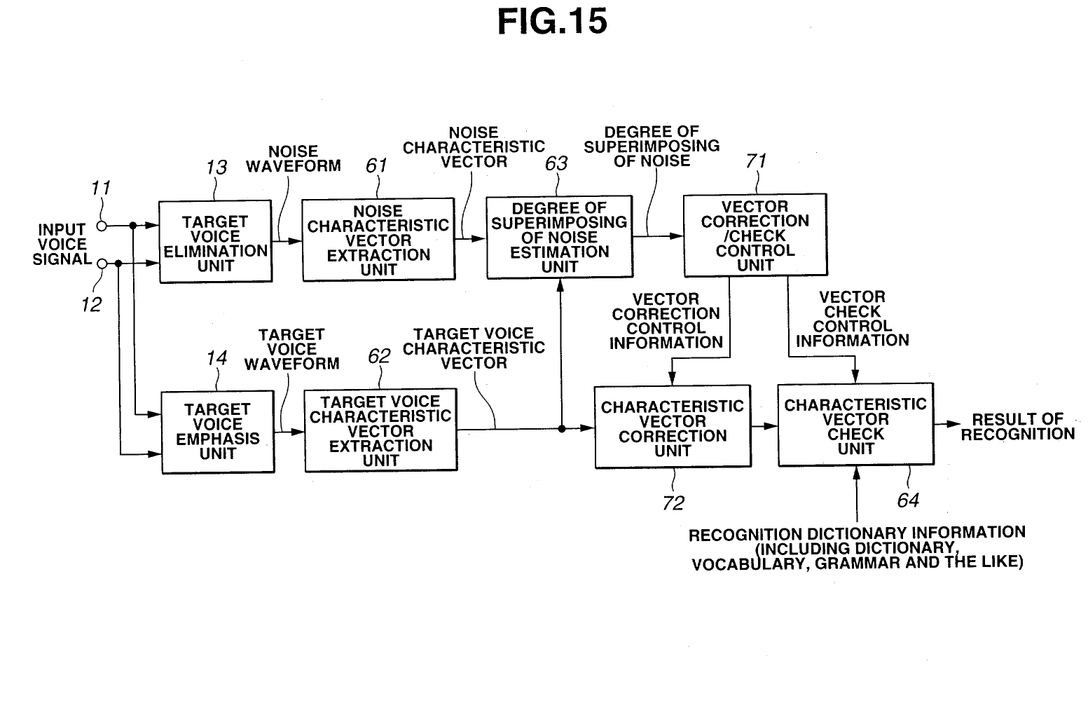

FIG. 15 is a block diagram showing a fifth embodiment of the present invention. In FIG. 15, the same components as those in FIG. 12 are denoted by the same reference numerals and the description thereof is omitted.

The embodiment is arranged such that, in missing feature processing, characteristic vector correction processing and pattern check processing, which is executed in an speech recognition engine, are controlled according to a degree of multiplexing of noise.

The fifth embodiment is different from the fourth embodiment in that a vector correction/check control unit 71 and a characteristic vector correction unit 72 are added thereto. The characteristic vector correction unit 72 is supplied with a target voice characteristic vector from a target voice characteristic vector extraction unit 62 and with vector correction control information from the vector correction/check control unit 71, corrects the target voice characteristic vector, and supplies it to a characteristic vector check unit 64. For example, the characteristic vector correction unit 72 corrects the target voice characteristic vector using the clustering method shown in FIG. 7, and the like.

In this embodiment, the vector correction/check control unit 71 controls the correction of the characteristic vector based on the degree of multiplexing of noise as well as controls the pattern check processing executed in the characteristic vector check unit 64.

For example, the vector correction/check control unit 71 sets threshold values a and b similarly to FIG. 13 and adjusts the check score of the characteristic vector check unit 64 according to characteristic vector check/control information. Further, when the degree of multiplexing of noise is smaller than a predetermined value c which is smaller than the threshold value b, the vector correction/check control unit 71 determines that the characteristic vector can be effectively corrected by the characteristic vector correction unit 72 and outputs characteristic vector correction control information for indicating the correction of the characteristic vector. When the degree of multiplexing of noise is larger than the threshold value c, the vector correction/check control unit 71 determines that the characteristic vector can not be effectively corrected by the characteristic vector correction unit 72 and prohibits the correction of the characteristic vector.

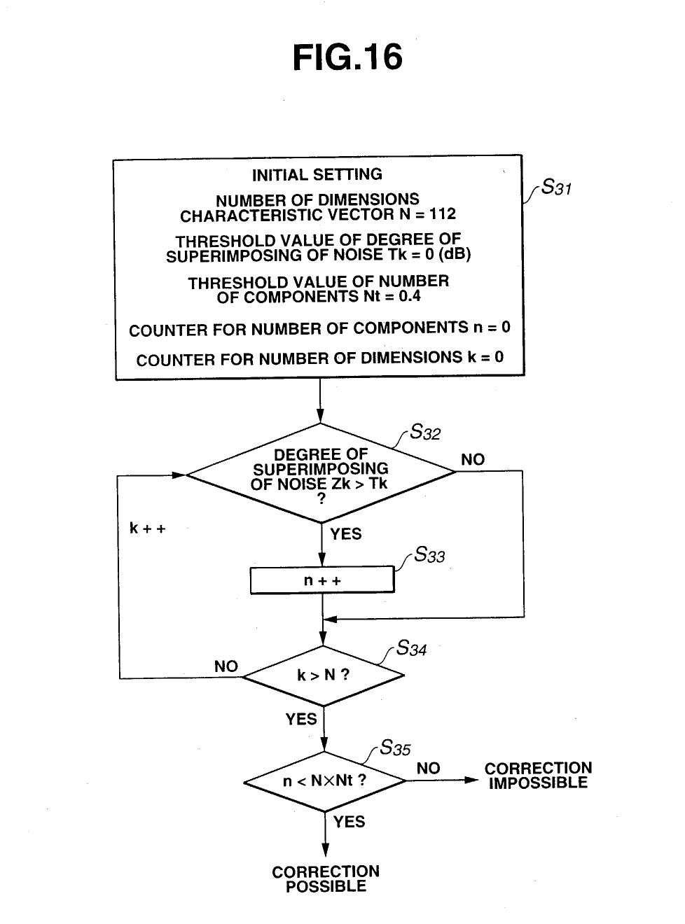

Next, operation of the fifth embodiment arranged as described above will be described with reference to a flowchart of FIG. 16. FIG. 16 shows an example of a method of creating the vector correction control information in the vector correction/check control unit 71.

The vector correction/check control unit 71 is supplied with the degree of multiplexing of noise from a degree of multiplexing of noise estimation unit 63. The vector correction/check control unit 71 sets various initial states at step S31 of FIG. 16. For example, the vector correction/check control unit 71 sets the number of characteristic vector dimensions N to the number of dimensions (the number of bands, 112 in the example of FIG. 16) in the noise characteristic vector extraction unit 61. Then, the vector correction/check control unit 71 sets the threshold value Tk of the degree of multiplexing of noise. In the example of FIG. 16, the threshold value Tk is set to 0(dB), and whether or not a noise power exceeds a signal power is determined based on the threshold value. Next, the vector correction/check control unit 71 sets the threshold value Nt of the number of components. In the example of FIG. 16, Nt is set to 0.4. Then, a number of dimensions counter k indicating the number of dimensions is initialized to 0, and a number of components counter n indicating the number of dimensions exceeding the threshold value Tk is initialized to 0.

The vector correction/check control unit 71 is supplied with the degree of multiplexing of noise of each dimension (band) as to each frame. At step S32, the vector correction/check control unit 71 determines whether or not a degree of multiplexing of noise Z(k) exceeds the threshold value Tk. When the degree of multiplexing of noise Z(k) exceeds the threshold value Tk, the number of components counter n is incremented by 1 (step S33). At step S34, it is determined whether or not the above determination has been executed as to all the dimensions.

When the determination has not been executed as to all the dimensions, the number of dimensions counter k is incremented by 1, and the process returns to step S32. When the determination has been executed as to all the dimensions, the process goes to step S35, and it is determined whether or not the number of dimensions whose degree of multiplexing of noise exceeds the threshold value Tk exceeds the threshold value Nt of the number of components.

When the number of dimensions whose degrees of multiplexing of noise exceed the threshold value Tk does not exceed 40% (Nt=0.4) of all the number of dimensions, the vector correction/check control unit 71 determines that it is effective to correct the target voice spectrum information of a subject frame and that otherwise it is not effective.

That is, the vector correction/check control unit 71 determines whether or not the characteristic vector can be corrected depending upon whether or not noise is strongly superimposed in a wide range with respect to the characteristic vector. As described above, when the number of components is smaller than 40% at the time the degree of multiplexing of noise is more than the threshold value Tk, the vector correction/check control unit 71 determines that the characteristic vector can be corrected on the assumption that the noise is locally superimposed.

When the vector correction/check control unit 71 determines based on the degree of multiplexing of noise that the target voice characteristic vector can be corrected with high accuracy, it outputs a value indicating “to execute correction processing” as the vector correction control information. Further, in this case, the vector correction/check control unit 71 outputs a value indicating “not to execute check control” as vector check control information.

Accordingly, in this case, the target voice characteristic vector from the target voice characteristic vector extraction unit 62 is corrected in the characteristic vector correction unit 72, and the characteristic vector check unit 64 obtains a result of speech recognition using the check score as it is.

Further, when the vector correction/check control unit 71 determines that the correction is not effective, it outputs a value indicating “not to execute correction processing” as the vector correction control information and outputs a value indicating “to execute check control” according to the method shown, for example, in FIG. 13 as the vector check control information.

Accordingly, in this case, the target voice characteristic vector from the target voice characteristic vector extraction unit 62 is not corrected by the characteristic vector correction unit 72 and is supplied to the characteristic vector check unit 64 as it is. The characteristic vector check unit 64 applies a predetermined weight to the check score by executing an adjustment similar to that of FIG. 13 or converts the check score to a given value to thereby obtain a result of speech recognition.

As described above, this embodiment determines whether or not a spectrum can be effectively corrected using the degree of multiplexing of noise determined as to each dimension of the characteristic vector of each frame. When the spectrum is corrected by the clustering method, spectrum information nearest to an input spectrum information is selected from spectrum information created from a clear voice. Since the spectrum information used to check the characteristic vector contains no noise component, the check score is very reliable, and a voice can be recognized with high accuracy. That is, when noise is biased to a specific spectrum component or time, the spectrum information of the clear voice can be accurately selected. Thus, the spectrum information of an original voice can be sufficiently restored, thereby an excellent recognition performance can be obtained without changing input data to be recognized. However, when noise is superimposed in a wide region (frequency and time regions), there is a possibility that a check accuracy is deteriorated because the spectrum information of the original voice is greatly lost. Since the embodiment is arranged such that the spectrum correction method and the recognition check control are switched based on the extent of the region in which noise is superimposed and on the degree of multiplexing of noise, thereby a voice can be recognized with high accuracy.

Note that, in the embodiment of FIG. 2, the input voice signal is supplied to the target voice emphasis unit 14 and output to the target voice spectrum information extraction unit 16 after a target voice signal is emphasized. However, the target voice emphasis unit 14 may be omitted. In this case, the target voice spectrum information extraction unit 16 extracts the target voice spectrum information from the input signal. The degree of multiplexing of noise estimation unit 17 can determine the degree of multiplexing of noise also in this case while accuracy is somewhat deteriorated.

Likewise, in the embodiment of FIG. 8, the input spectrum information is supplied to the target voice emphasis unit 43 and output to the degree of multiplexing of noises estimation unit 17 after the target voice spectrum is emphasized. However, the target voice emphasis unit 43 may be omitted. In this case, for example, the input spectrum information from the frequency analysis unit 41 is supplied to a switch SW2, which selects one of two input signals and outputs it to the degree of multiplexing of noise estimation unit 17 and to the spectrum information correction unit 18. In this case, the input spectrum information is supplied as it is to the degree of multiplexing of noise estimation unit 17 and to the spectrum information correction unit 18 through the switch SW2. The degree of multiplexing of noise estimation unit 17 can determine the degree of multiplexing of noise also in this case while accuracy is somewhat deteriorated.

Having described the preferred embodiments of the invention referring to the accompanying drawings, it should be understood that the present invention is not limited to those precise embodiments and various changes and modifications thereof could be made by one skilled in the without departing from the spirit or scope of the invention as defined in the appended claims.

What is claimed is:

1. A noise suppression apparatus for speech recognition comprising:
a target voice emphasis unit, which is supplied with input voice signals from a plurality of channels of a microphone array, which emphasizes a target voice from the input voice signals, and which outputs a target voice emphasis signal;
a target voice characteristic vector extraction unit which analyzes the target voice emphasis signal and which calculates a target voice characteristic vector to be subjected to speech recognition;
a target voice elimination unit, which is supplied with the input voice signals which eliminates the target voice from the input voices signals and which outputs a target voice elimination signal;
a noise characteristic vector extraction unit which analyzes the target voice elimination signal and which calculates a noise characteristic vector; and
a degree of multiplexing of noise estimation unit which estimates a degree of multiplexing of noise every predetermined unit time based on the noise characteristic vector and the target voice characteristic vector.

2. A noise suppression apparatus for speech recognition according to claim 1, wherein the degree of multiplexing of noise estimation unit estimates the degree of multiplexing of noise each component of the target voice characteristic vector.

3. A noise suppression apparatus for speech recognition according to claim 1, wherein the target voice elimination unit comprises at least one of an adaptive beam former and a fixed beam former.

4. A noise suppression apparatus for speech recognition according to claim 1, wherein the target voice emphasis unit comprises at least one of an adaptive beam former and a fixed beam former.

5. A noise suppression apparatus for speech recognition according to claim 1, wherein the target voice emphasis unit outputs one of the input voice signals of the plurality of channels as the target voice emphasis signal.

6. A noise suppression apparatus for speech recognition comprising:
a frequency analysis unit which analyzes frequencies of input voice signals from a plurality of channels of a microphone array each channel and which generates input spectrum information from results analyzed frequencies of the input voice signals;
a target voice emphasis unit, which emphasizes a target voice component based on the input spectrum information of the plurality of channels and which calculates a target voice spectrum information;
a target voice characteristic vector extraction unit which analyzes the target voice spectrum information and which extracts a target voice characteristic vector to be subjected to speech recognition;
a target voice elimination unit which eliminates a target voice component based on the input spectrum information of the plurality of channels and which calculates a noise spectrum information;
a noise characteristic vector extraction unit which analyzes the noise spectrum information and which extracts a noise characteristic vector; and
a degree of multiplexing of noise estimation unit which estimates a degree of multiplexing of noise every predetermined unit time based on the noise characteristic vector and the target voice characteristic vector.

7. A noise suppression apparatus for speech recognition according to claim 6, wherein the degree of multiplexing of noise estimation unit estimates the degree of multiplexing of noise each component of the target voice characteristic vector.

8. A noise suppression apparatus for speech recognition according to claim 7, wherein the target voice elimination unit comprises at least one of an adaptive beam former and a fixed beam former.

9. A noise suppression apparatus for speech recognition according to claim 6, wherein the target voice emphasis unit comprises at least one of an adaptive beam former and a fixed beam former.

10. A noise suppression apparatus for speech recognition according to claim 6, wherein the target voice emphasis unit outputs one of the input spectrum information of the plurality of channels as the target voice spectrum information.

11. A noise suppression apparatus for speech recognition comprising:
a target voice elimination unit, which is supplied with input voice signals from a plurality of channels of a microphone array, which eliminates a target voice from the input voice signals, and which outputs a target voice elimination signal;
a noise spectrum information extraction unit which analyzes frequencies of the target voice elimination signal and which calculates a noise spectrum information from results analyzed frequencies of the target voice elimination signal;
a target voice emphasis unit, which is supplied with the input voice signals from the plurality of channels, which emphasizes the target voice from the input voice signals, and which outputs a target voice emphasis signal;
a target voice spectrum information extraction unit which analyzes frequencies of the target voice emphasis signal and which calculates a target voice spectrum information from results analyzed frequencies of the target voice emphasis signal; and
a degree of multiplexing of noise estimation unit which estimates a degree of multiplexing of noise every predetermined unit time based on the noise spectrum information and the target voice spectrum information.

12. A noise suppression apparatus for speech recognition according to claim 11, wherein the degree of multiplexing of noise estimation unit estimates the degree of multiplexing of noise each frequency band of the target voice.

13. A noise suppression apparatus for speech recognition according to claim 11, wherein the target voice elimination unit comprises at least one of an adaptive beam former and a fixed beam former.

14. A noise suppression apparatus for speech recognition according to claim 11, wherein the target voice emphasis unit comprises at least one of an adaptive beam former and a fixed beam former.

15. A noise suppression apparatus for speech recognition according to claim 11, wherein the target voice emphasis unit outputs one of the input voice signals of the plurality of channels as the target voice emphasis signal.

16. A noise suppression apparatus for speech recognition comprising:
a frequency analysis unit which analyzes frequencies of input voice signals from a plurality of channels of a microphone array for each channel;
a target voice elimination unit, which is supplied with input spectrum information of the plurality of channels obtained by the frequency analysis unit, which eliminates a target voice component based on the input spectrum information, and which calculates a noise spectrum information from results eliminated the target voice component;
a target voice emphasis unit, which is supplied with the input spectrum information of the plurality of channels, which emphasizes the target voice based on the input spectrum information, and which calculates a target voice spectrum information from results emphasized the target voice; and
a degree of multiplexing of noise estimation unit for estimates a degree of multiplexing of noise every predetermined unit time based on the target voice spectrum information and the noise spectrum.

17. A noise suppression apparatus for speech recognition according to claim 16, wherein the degree of multiplexing of noise estimation unit estimates the degree of multiplexing of noise for each frequency band of the target voice.

18. A noise suppression apparatus for speech recognition according to claim 16, wherein the target voice elimination unit comprises at least one of an adaptive beam former and a fixed beam former.

19. A noise suppression apparatus for speech recognition according to claim 16, wherein the target voice emphasis unit comprises at least one of an adaptive beam former and a fixed beam former.

20. A noise suppression apparatus for speech recognition according to claim 16, wherein the target voice emphasis unit outputs one of the input spectrum information of the plurality of channels as the target voice spectrum information.

21. A speech recognition apparatus comprising:
the noise suppression apparatus for speech recognition according to claim 1; and
a target voice characteristic vector check unit which checks the target voice characteristic vector with a recognition dictionary and which adjusts a result of check based on the degree of multiplexing of noise.

22. A noise suppression apparatus for speech recognition according to claim 21, further comprising:
a characteristic vector correction unit which corrects the target voice characteristic vector to be subjected to speech recognition to a pattern less influenced by noise; and
a vector correction/check control unit which generates a control signal, wherein the control signal controls a correction process of the characteristic vector correction unit and a check process of the characteristic vector check unit based on the degree of multiplexing of noise.

23. A speech recognition apparatus comprising:
the noise suppression apparatus for speech recognition according to claim 6; and
a target voice characteristic vector check unit which checks the target voice characteristic vector with a recognition dictionary which adjusts a result of check based on the degree of multiplexing of noise.

24. A noise suppression apparatus for speech recognition according to claim 23, further comprising:
a characteristic vector correction unit which corrects the target voice characteristic vector to be subjected to speech recognition to a pattern less influenced by noise; and
a vector correction/check control unit which generates a control signal, wherein the control signal controls a correction process of the characteristic vector correction unit and a check process of the characteristic vector check unit based on the degree of multiplexing of noise.

25. A speech recognition apparatus comprising:
the noise suppression apparatus for speech recognition according to claim 11; and
a spectrum information correction unit which corrects the target voice spectrum information so as to eliminate the influence of noise based on the degree of multiplexing of noise.

26. A speech recognition apparatus according to claim 25, wherein the spectrum information correction unit comprising:
a reference spectrum information selection unit, which selects one of a plurality of reference spectrum information used of voice data including no noise, which replaces or corrects the selected reference spectrum information with or according to the target voice spectrum information, and which determines whether or not the replacement or the correction is possible based on the degree of multiplexing of noise; and
a spectrum information reconstruction unit which corrects the target voice spectrum information based on the selected reference spectrum information.

27. A speech recognition apparatus comprising:
the noise suppression apparatus for speech recognition according to claim 16; and
a spectrum information correction unit which corrects the target voice spectrum information so as to eliminate the influence of noise based on the degree of multiplexing of noise.

28. A speech recognition apparatus according to claim 27, wherein the spectrum information correction unit comprising:
a reference spectrum information selection unit, which selects one of a plurality of reference spectrum information used a voice data including no noise, which replaces or corrects the selected reference spectrum information with or according to the target voice spectrum information, and which determines whether or not the replacement or the correction is possible based on the degree of multiplexing of noise; and
a spectrum information reconstruction unit which corrects the target voice spectrum information based on the selected reference spectrum information.

29. A noise suppression method for speech recognition comprising:
a step, which is supplied with input voice signals from a plurality of channels of a microphone array, which eliminates a target voice from the input voice signals, and outputs a target voice elimination signal;
a noise characteristic vector extraction step which analyzes the target voice elimination signal and calculates a noise characteristic vector;
a step, which is supplied with the input voice signals from the plurality of channels, which emphasizes the target voice from the input voice signals, and which outputs a target voice emphasis signal;
a target voice characteristic vector extraction step which analyzes the target voice emphasis signal and which calculates a target voice characteristic vector; and
a degree of multiplexing of noise estimation step which estimates a degree of multiplexing of noise every predetermined unit time based on the characteristic vector and the target voice characteristic vector.

30. A noise suppression method for speech recognition according to claim 29, wherein a frequency spectrum is used as the characteristic vector.

31. A speech recognition method comprising:
the respective steps of a noise suppression method for speech recognition according to claim 30; and
a spectrum information correction step of correcting the target voice spectrum information so as to eliminate the influence of noise therefrom based on the degree of multiplexing of noise estimated by the degree of multiplexing of noise estimation step and for outputting the thus corrected target voice spectrum information.

32. A noise suppression method for speech recognition comprising:
a frequency analysis step which analyzes frequencies of input voice signals from a plurality of channels of a microphone array each channel and which generates input spectrum information from results analyzed frequencies of the input voice signals;
a step, at which the input spectrum information of the plurality of channels is supplied, which emphasizes a target voice input spectrum information and which calculates the spectrum information of the target voice;
a target voice characteristic vector extraction step which analyzes the target voice spectrum information and extracting a target voice characteristic vector to be subjected to speech recognition;
a target voice elimination step which eliminates a target voice component included in the input spectrum information based on the input spectrum information of the plurality of channels and which calculates the noise spectrum information;
a noise characteristic vector extraction step which analyzes the noise spectrum information and which extracts a noise characteristic vector; and
a degree of multiplexing of noise estimation step which estimates a degree of multiplexing of noise each characteristic vector component and as to each unit time based on the noise characteristic vector and the target voice characteristic vector.

33. A noise suppression method for speech recognition according to claim 32, wherein a frequency spectrum is used as the characteristic vector.

34. A speech recognition method comprising:
the respective steps of a noise suppression method for speech recognition according to claim 33; and
a spectrum information correction step which corrects the target voice spectrum information so as to eliminate the influence of noise based on the degree of multiplexing of noise.

35. A noise suppression method for speech recognition comprising:
a frequency analysis step which analyzes the frequencies of input voice signals of a plurality of channels of a microphone array for each channel;
a step, which is supplied with the input spectrum information from the plurality of channels, which emphasizes a target voice input spectrum information and for calculating the spectrum information of the target voice;
a target voice characteristic vector extraction step which analyzes the target voice spectrum information and which extracts a target voice characteristic vector to be subjected to speech recognition;
a target voice elimination step of eliminating a target voice component based on the input spectrum information of the plurality of channels and which calculates the noise spectrum information;
a noise characteristic vector extraction step which analyzes the noise spectrum information and which extracts a noise characteristic vector;
a degree of multiplexing of noise estimation step which estimates a degree of multiplexing of noise each characteristic vector component and as to each unit time based on the noise characteristic vector obtained by the noise characteristic vector extraction step and on the target voice characteristic vector obtained by the target voice characteristic vector extraction step; and
a characteristic vector correction control step which determinines whether or not it is possible to correct the target voice characteristic vector depending upon whether or not the number of components of the target voice characteristic vector, in which the degrees of multiplexing of noise thereof exceed a predetermined threshold value, of all the number of components of the target voice characteristic vector exceeds a predetermined ratio.

36. A product of a noise suppression program for speech recognition for causing a computer to execute:
processing, in which input voice signals of a plurality of channels of a microphone array are supplied, for eliminating a target voice and outputting a target voice eliminated signal;
processing for analyzing the frequency of the target voice elimination signal and which calculates the spectrum information of a noise component;
processing, in which the input voice signals of the plurality of channels are supplied, which emphasizes the target voice from the input signals and which outputs a target voice emphasis signal;
target voice spectrum information extraction processing for analyzing the frequency of the target voice emphasized signal and calculating the spectrum information of the target voice; and
degree of multiplexing of noise estimation processing which estimates a degree of multiplexing of noise every predetermined unit time based on the spectrum information of the noise component and on the spectrum information of the target voice.

37. A product of a speech recognition program for causing a computer to execute:
the respective steps of the processing of the product of the noise suppression program for speech recognition according to claim 36; and
spectrum information correction processing which corrects the target voice spectrum information so as to eliminate the influence of noise based on the degree of multiplexing of noise estimated by the degree of multiplexing of noise.
